(19) United States
(12) Patent Application Publication
(10) Pub. No.: US 2012/0218633 A1
(43) Pub. Date: Aug. 30, 2012

(54) TARGETS, TARGET TRAINING SYSTEMS, AND METHODS

(76) Inventors: K. Dominic Cincotti, Wilmington, NC (US); Fred Mark Tocci, Wilmington, NC (US)

(21) Appl. No.: 13/405,109

(22) Filed: Feb. 24, 2012

Related U.S. Application Data
(60) Provisional application No. 61/446,395, filed on Feb. 24, 2011.

(51) Int. Cl. F41J 1/01; G02B 27/22; G02B 27/12

(52) U.S. Cl. 359/463; 359/619; 273/348.1; 273/409

(57) ABSTRACT

Targets, target systems, and related methods are provided. The targets can provide non-electric or low electric dynamic imagery and/or thermal signature capabilities that can be used in target systems. For example, a target can include a substrate forming a target body and having a front side. A combined image is disposed on the front side of the substrate with the combined image including a combination of at least two primary images of a potential target provided through lenticular printing. A lenticular lens can be disposed over the combined image so that the combined image and the lenticular lens generate an observed image of the potential target body when viewed by an observer. Additionally or alternatively, a target can be provided that includes a substrate forming a target body and at least one substance disposed on the substrate configured to create a thermal signature mimicking a potential target.

### RELATED APPLICATION

The presently disclosed subject matter claims the benefit of and priority to U.S. Provisional Patent Application Ser. No. 61/446,395, filed Feb. 24, 2011, the disclosure of which is incorporated herein by reference in its entirety.

### TECHNICAL FIELD

The subject matter disclosed herein relates to targets, target training systems and related methods. In particular, the present subject matter relates to advance firearm targets that can be visually and/or thermally enhanced and related training systems and methods.

### BACKGROUND

Although human brain circuits are genetically programmed to judge depth from visual cues, it takes experience to calibrate them. Initially, children are bad at judging distance, but over time they train their brain to calculate distance. By adulthood, people become experts at judging depth but only with regard to objects in familiar environments. In unfamiliar territory, such as a new mountainous trail, automatic depth judgment fails because a person's brain has not yet calibrated to new clues in the environment. In these new scenarios, people have to retrain their brains to compute distance.

An unpredictable and adaptable threat makes it imperative to improve complex (tactical and human) decision making skills and places a premium on having the agility to develop and implement new tactics. One area in particular that needs to be better exploited is how to provide and leverage new realistic immersive training environments in military and law enforcement training.

Target training has evolved over the years to meet the needs and incorporate the lessons learned through experience and study of past conflicts and wars. Both the successes and failures are lessons that serve as scenarios for training and that can yield products to increase effective training techniques.

Bull's-eye type targets were initially used to provide target training. It was found that while bull's-eye type targets improved marksmanship, these targets did not help trainees prepare for the demands of combat situations and scenarios. These bull's-eye type targets were later replaced with paper silhouette targets to give the target more of an appearance of an enemy combatant and to provide training on areas of the body to shoot. A further improvement for situational training occurred with the use of threat and non-threat silhouette paper targets so that the trainee could train to distinguish which person to fire upon.

Additional training improvements include adding two-dimensional photographic type images to silhouette targets. Molded plastic targets with a three-dimensional relief of the human figure have also been used. For quick decision training, targets on automated movers can be used that can swing out from windows or doorways at physical sites. These target systems reflect the nature of current and emerging warfare directions, such as unconventional and urban warfare environments.

While such targets with two-dimensional images or molded plastic targets of the human figure improve the appearance of the targets, these targets do not give the trainee a true sense of being in the action where split-second decisions to determine whether a person is a threat or non-threat need to be made.

### SUMMARY

It is an object of the presently disclosed subject matter to provide novel firearm targets, target training systems and related methods. For example, the present subject matter relates to advance firearm targets that can be visually and/or thermally enhanced and related training systems and methods.

An object of the presently disclosed subject matter having been stated hereinabove, and which is achieved in whole or in part by the presently disclosed subject matter, other objects will become evident as the description proceeds when taken in connection with the accompanying drawings as best described hereinbelow.

### BRIEF DESCRIPTION OF THE DRAWINGS

A full and enabling disclosure of the present subject matter including the best mode thereof to one of ordinary skill in the art is set forth more particularly in the remainder of the specification, including reference to the accompanying figures, in which:

FIG. 1A illustrates an example embodiment of images that can be combined to create a three-dimensional image for an embodiment of a potential target in accordance with the present subject matter;

FIG. 1B illustrates an example embodiment of a three-dimensional image created from the images in accordance with FIG. 1A;

FIG. 2 illustrates a schematic diagram of a portion of an embodiment of a lenticular printing process used to create an image for an embodiment of a target in accordance with the present subject matter;

FIGS. 3A and 3B illustrate schematic top and side views of an embodiment of a target in accordance with the present subject matter;

FIG. 4 illustrates a rear schematic view of an embodiment of a target in accordance with the present subject matter;

FIGS. 5A and 5B illustrate related front views of an embodiment of a target in accordance with the present subject matter;

FIG. 5C illustrates a front view of an embodiment of a target in accordance with the present subject matter;

FIGS. 6A and 6B illustrate related front views of an embodiment of a target in accordance with the present subject matter; and

FIGS. 7-9 illustrate example images that can be observed on embodiments of targets or in embodiments of target systems in accordance with the present subject matter;

FIG. 10 illustrates front schematic views of a series of observed images of an embodiment of a target created by observation from different viewing angles in accordance with the present subject matter;

FIG. 11 illustrates a perspective view of a portion of an example embodiment of a target training system that can use embodiments of targets in accordance with the present subject matter;

FIGS. 12A-12B illustrate perspective views of a portion of another example embodiment of a target training system that can use embodiments of targets in accordance with the present subject matter; and

FIGS. 13A-13B illustrate perspective views of portions of a further example embodiment of a target training system that can use embodiments of targets in accordance with the present subject matter.

### DETAILED DESCRIPTION

Reference will now be made in detail to the description of the present subject matter, one or more examples of which are shown in the figures. Each example is provided to explain the subject matter and not as a limitation. In fact, features illustrated or described as part of one embodiment may be used in another embodiment to yield still a further embodiment. It is intended that the present subject matter cover such modifications and variations.

Although the terms first, second, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the disclosure herein.

Embodiments of the subject matter of the disclosure are described herein with reference to schematic illustrations of embodiments that may be idealized. As such, variations from the shapes and/or positions of features, elements or components within the illustrations as a result of, for example but not limited to, user preferences, manufacturing techniques and/or tolerances are expected. Shapes, sizes and/or positions of features, elements or components illustrated in the figures may also be magnified, minimized, exaggerated, shifted or simplified to facilitate explanation of the subject matter disclosed herein. Thus, the features, elements or components illustrated in the figures may be schematic in nature and their shapes and/or positions are not intended to illustrate the precise configuration of a system or apparatus and are not intended to limit the scope of the subject matter disclosed herein.

“Image” as used herein means the optical counterpart of an object or environment produced by graphical drawing by a person, a device (such as a computer, camera, smart device, or the like) or a combination thereof. The optical counterpart of the object can also be produced by an optical device, electromechanical device, or electronic device. As used herein, “image” can be used to refer to a whole image, for example, a photographic image as taken by a photographic device, or a portion thereof.

“Primary image” or “primary images” as used herein means one or more images created by a person, device, or combination thereof that is use to create a combined image for lenticular printing.

“Combined image” as used herein means one or more primary images combined in a specific manner for lenticular printing. “Observed image” as used herein means an image as perceived by an observer.

“Inter-ocular distance” as used herein means the distance between an average human's eyes.

“Lenticular lens” as used herein means an array of magnifying lenses, designed so that when viewed from different angles, different images are magnified.

“Lenticular printing” as used herein means a technology in which a lenticular lens is used to produce images with an illusion of depth, or the ability to change or move as the image is viewed from different angles. For example, two or more primary images can be combined in a specific manner and then printed on a graphic media with a lenticular lens applied thereto. As an example, but not as a limitation, left eye and right eye images can be combined into an image of a specific pattern of the left eye and right eye images and then printed using a graphic media on a substrate such as a vinyl film layer with a lenticular lens disposed on a top surface of the substrate over the printed combined image.

Alternatively, as an example, but not as a limitation, the combined image can be printed using a graphic media on a rear surface of a lenticular lens. The lenticular lens can be, for example, a specially ridged transparent film with the ridges creating thin lenses that due to the lenticular lens' placement relative to the combined image can create a three-dimensional appearance of the combined image as the substrate and/or the observer moves relative to one another.

“Parallax” as used herein means determining and/or measuring distance to target.

“Stereopsis” as used herein means the process in visible perception leading to the perception of depth from the two slightly different projections of the world onto the different retinas of the two eyes. For example, with human vision with two eyes in slightly differing locations, two varied overlapping images provide one image with the perception of depth.

“Thermal heat signature” as used herein means a typical image that would be produced when viewing an object(s), vehicle(s), animal(s), or human(s) with a thermal imaging system, thermal weapon sight, a thermal scope, thermal goggles, thermal sensor detection apparatus, or the like, that has a viewable display or video output.

Embodiments of targets, target systems, and related methods are provided herein. The targets can provide non-electric or low electric dynamic imagery and/or thermal signature capabilities that can be used in target systems. For example, in some embodiments, a target can comprise a substrate forming a target body and having a front side. A combined image can be disposed on the front side of the substrate with the combined image including a combination of at least two primary images of a potential target provided through lenticular printing. A lenticular lens can be disposed over the combined image. The combined image and the lenticular lens can generate an observed image of the potential target when viewed by an observer.

In some embodiments, the combined image and the lenticular lens can generate a first observed image of a non-threat image on the target body when observed from a first angle and a second observed image of a threat image on the target body when observed from a second angle. Alternatively, the combined image and the lenticular lens can generate a first observed image of a non-threat image on the target body when observed from a first angle and a second observed image of a non-threat image on the target body when observed from a second angle. In some embodiments, the combined image and the lenticular lens can generate a series of observed images of the potential target as an angle of observation changes for the observer. For example, the observed images of the potential target can imitate motion of the potential target. In such instances, the series of observed images of the potential target can be sequential. In some embodiments, the combined image and the lenticular lens can generate a three-dimensional observed image of the potential target. Thus, in the manner described, the combined image and the lenticular lens can create at least one of a transforming effect, an animated effect, or a stereopsis effect to generate the observed image of the potential target when viewed by an observer.

Additionally or alternatively, in some embodiments, a target can comprise a substrate forming a target body and at least one substance disposed on the substrate configured to create a thermal signature mimicking a potential target. For example, the at least one substance can be non-electrically heated or ignited to create the thermal signature. In some embodiments, the at least one substance can comprise a chemical composition. For example, the at least one substance can comprise an air-activated charcoal that produces heat when exposed to air. The air-activated charcoal can be disposed in a container on a back surface of the substrate with an adhesive layer that is removable to allow air flow into the container to begin heat activation of the charcoal. Embodiments that have such thermal signature components can also comprise an image of a person or physical object disposed on a front surface of the substrate. As above, the image can be a combined image disposed on the front side of the substrate. The combined image can comprise a combination of at least two primary images of a potential target provided through lenticular printing. A lenticular lens can be disposed over the combined image so that the combined image and the lenticular lens can generate one or more observed images of the potential target when viewed by an observer as described above.

As stated above, the different embodiments of targets can be used in target systems. In some embodiments, a target training system can be provided that comprises at least one carrier and one or more targets. At least one of targets can be disposed on the carrier. In some embodiments, one or more of the targets can comprise a substrate forming a target body and at least one substance disposed on the substrate configured to create a thermal signature mimicking a potential target as described above. Additionally or alternatively, one or more of targets can comprise a substrate forming a target body and having a front side with a combined image of a combination of at least two primary images of a potential target provided through lenticular printing disposed on the front side of the substrate. A lenticular lens can be disposed over the combined image. The combined image and the lenticular lens can generate an observed image of the potential target when viewed by an observer. The combined image and the lenticular lens can generate one or more observed images of the potential target when viewed by an observer as described above.

Also as stated above, the different embodiments of methods related to the target and target systems are provided herein. For example, methods of creating a target are provided herein. In some embodiments, the method of creating a target can comprise providing a substrate having a front side and a back side and shaping the substrate into a target body. The method can also comprise attaching a substance on the back side of the substrate in a pattern that, when the substance is activated, creates a thermal signature mimicking a potential target. The substance can be attached in different ways. For example, the substance can be placed in one or more containers that can be positioned on the back side of the substrate in a pattern that can create a thermal signature that mimics a potential target when the substance is activated. In some embodiments, the container can comprise an adhesive layer that is removable to allow air flow into the container to activate the substance. Such containers can be pouches attached to the back side of the substrate. In some embodiments, the substance can comprise an air-activated charcoal that produces heat when exposed to air.

In some embodiments of the method, an image can be printed on the front side of the substrate. In such embodiments, the image can be a combined image that can comprise a combination of at least two primary images of a potential target provided through lenticular printing. A lenticular lens can be secured over the combined image so that the combined image and the lenticular lens generate an observed image of the potential target when viewed by an observer. Alternatively, in some embodiments, a combined image comprising a combination of at least two primary images of a potential target can be printed onto a rear surface of a lenticular lens so that the combined image and the lenticular lens generate an observed image of the potential target body when viewed by an observer and securing a lenticular lens to the front side of the of the substrate. Lenticular printing and/or chemical reactions that can produce thermal heat signatures can be used to create advanced firearm target training systems that can be non-electric. These target training systems can provide highly realistic three-dimensional and/or thermal characteristics with the systems being used for live fire and/or simulated live fire training. The training system can reinforce proper quick decision techniques, and advanced cultural immersion.

An advanced firearm target system can be provided as three-dimensional thermal signature firearm targets by three-dimensional stereoscopic photography with vinyl thin-films and polymers surface layers, or strata, that can include appropriately placed substances on the targets. These substances can provide chemical reactions/oxidization to enhance thermal signature of the targets to simulate a human thermal signature. These targets can be fitted upon conventional target carrier systems.

These targets can be considered to be within the field of non-electronic projectile weapon targets. These targets and targets systems can improve training by manipulating visual perception of the observer based on such perceptions as parallax/motion parallax, stereopsis, binocular vision, and three-dimensional photo imagery. Combining the knowledge of how to manipulate these perceptions of an observer with the knowledge of threat/non-threat/shoot/do not shoot targeting can lead to differing methods of target identification by simulated motion of a target. The simulated motion can be performed by a process that does not require any external apparatus, such as, for example, three-dimensional active and passive eyewear, colored eyewear, or polarized eyewear.

These visual perceptions of the observer are discussed in more detail below. As stated above, “parallax” is a term as used herein to mean determining and/or measuring distance to a target. The slightly differing perception of a target viewed by two visual receptors (i.e., your eyes, night vision goggles or thermal sensing goggles), with overlapping fields of perception, along differing vectoring lines with varied angles of inclination of those two vectors is the basis of parallax. When a shooter is in motion, seemingly relative motion of immobile targets in the foreground can give spatial and inferred cues concerning the targets distance. This is illustrated by relative motion within a vehicle. The targets near the subject's vehicle appear to move faster, while targets farther away from the vehicle and the observer therein appear to move slower or are seemly immobile.

Another monocular cue is motion parallax, which can occur when an observer moves his or her body (or just the head) to provide hints about the relative distance between objects. By moving the head back and forth, the motion can allow the observer to see objects from slightly different angles. A nearby object generally will move more quickly along the retina (creating a larger parallax) than a distant object, allowing you to determine which object is closer. When a person is driving a car, for instance, nearby things pass more quickly and faraway objects appear stationary.

Occlusion is a monocular cue whereby an object that is closer partly obstructs the faraway one. Occlusion can enable the brain to judge relative distances. When one object occludes another, the observer can rank the relative distances of these objects.

Binocular vision can provide more precise perception of depth, allowing us to judge small differences between the images on both retinas, whereas monocular vision gives us a larger field of view. The dominant eye of binocular vision is of prime importance in physical trials that require aiming as in firearm targeting. In this binocular vision, the parallax is determined by the dominant eye and that is used for accurate spatial information to the object/target.

The field of binocular vision for a shooter is approximately 140 degrees. The remaining 40 degrees are in the shooter's peripheral vision and do not have a binocular view. Light sensitivity and color perception is concentrated towards the center of the field of vision. The ability to sense motion is greater in the shooter's peripheral vision than towards the center of the field of vision. Peripheral vision is better during low light situations. This has the shooter often reacting to near-danger or rapid motion in his periphery with reflex rather than thought.

As targets recede, they seem to reduce in size. As that same target approaches the shooter that target seems to gain in size. This is known as kinetic depth perception. Kinetic depth perception can enable the mind to determine the amount of time an observer has until contact with a potential threat or non-threat, or time to contact. While the shooter is in motion, the shooter's mind is determining the time to contact with various objects and targets within the field of view of the shooter.

Targets and target training systems of the present subject matter can comprise three-dimensional stereoscopic images that allow limited but crucial animation of the target as the shooter's movement through an immersive training scenario occurs during live-fire shoots. Additionally or alternatively, the targets and target training systems can be provided with a thermal signature mimicking a person or physical object (potential target) that can be rendered through the use of substances such as chemicals. For example, air activated charcoal can be used to provide heat when exposed to air. The heat signature can be activated by removing an adhesive layer, thus allowing air flow to begin heat activation. The targets can thus use non-electric ways to animate/indicate motion and/or generate a human-like heat source by chemical reactions.

The targets and target training systems can operate to provide three-dimensional views and animated or transforming movement by manipulating the visual perceptions of the observer (which can be a trainee and or a shooter). These visual perceptions as described above can comprise parallax and motion parallax where motion of an image or object is use to determine or measure distance to a target. Motion parallax can comprise occlusion. The placement of one target/object before another is known as occlusion or blocking the sight by other objects give data concerning foreground, mid, and background rankings of what is of relative proximity to the shooter. Additionally or alternatively, motion parallax can comprise field of view, depth perception, color vision, peripheral vision, and binocular vision.

The system can utilize and manipulate these perceptions through the use of lenticular printing. Lenticular printing can do three things: simulate three-dimensional depth, animated motion, and allow one to place imagery in three different planes: front, middle and back. For example, lenticular printing can provide a “transforming effect,” or “transforming flip,” which can take an image of a person on a target from a non-threat having nothing in his hand to a threat having a weapon such as a gun in his hand. Lenticular printing can provide an animated motion effect that can create a morph or a zoom. A morph can be considered a change in shape and/or size of a portion of the image as the viewing angle changes. A zoom can be considered a change in zoom to the image in part or in its entirety. Lenticular printing can also provide stereoscopic effects that can be considered a three-dimensional effect that does not require special hardware such as active or passive glasses.

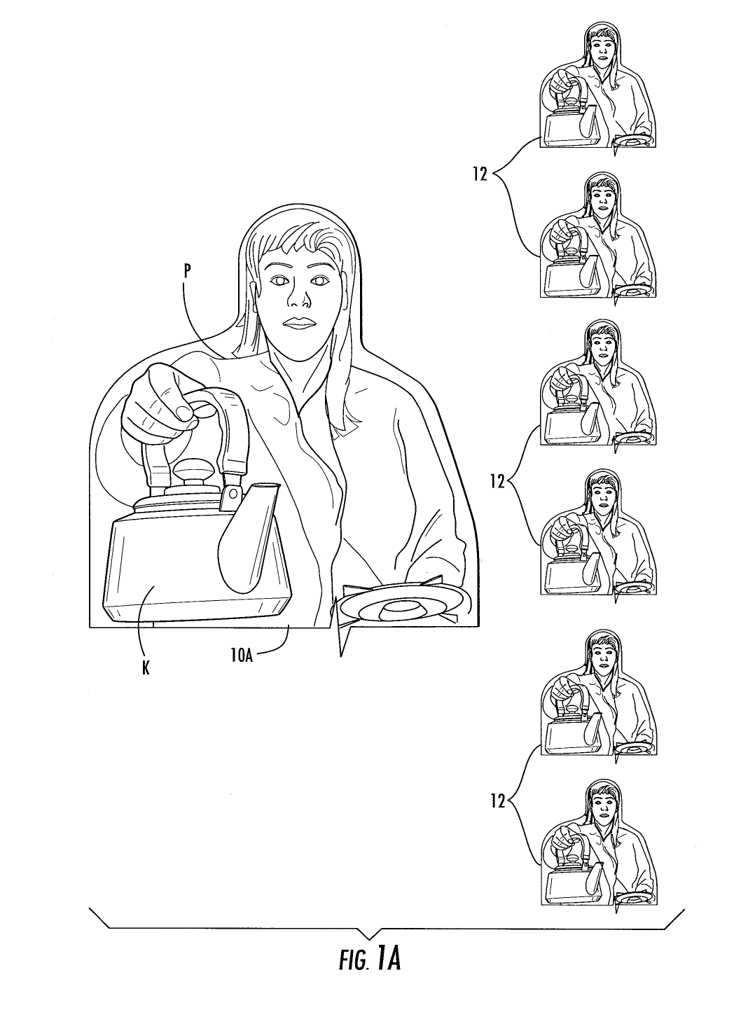

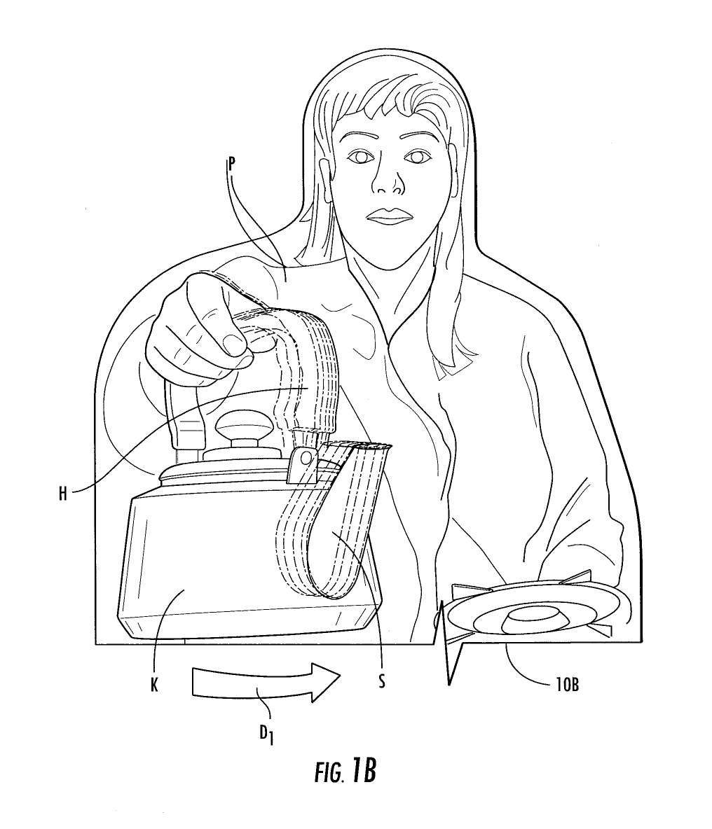

The lenticular printing can be created by utilizing images, photographs, and/or three-dimensional photography of the object/person to be used as the imagery for the target. For example, images of the object/person can be taken from different angles or by a three-dimensional camera. For example, the object/person can be videoed or photographed at slightly different angles, for instance, at inter-ocular distances. As shown in FIG. 1A, an image 10A is provided that can be an observed image when viewed by an observer that can have an observable depth to the image which provides a three-dimensionality to the observed image. Thereby, image 10A can provide a realistic sensory perception to the observer of the image of a real object and/or person being present before the observer. For instance, image 10A depicts a person P holding a kettle K. Image 10A can provide an observed image as viewed by an observer that has a perceived depth with person P appearing farther away and kettle K appearing closer. Additionally, features on person P, such as the nose and the drape of the clothes, and aspects of kettle K can be provided with more contrast. In particular, image 10A as observed in FIG. 1A can be a combined image created by a combining a plurality of primary images 12 in a specific manner and viewing image 10A through a special lens, such as a lenticular lens.

Depending on what the primary images are of, the number of primary images to be combined, how the primary images are combined and the type of lenticular lens used, the observed image or images can provide a wide range of visual sensory perception. For example, to create an observed image that has a high degree of three-dimensionality to it, image 10A can be created by taking a plurality of primary images 12, such as photographs, at slightly different angles and combining them together in a lenticular print to create a combined image and then placing a specific lenticular lens thereon. As the angle of observation fluctuates or changes, the observed image is perceived as having a depth that is not provided by the primary images alone.

FIG. 1B shows, for example, a different feature of a similar image 10B that when viewed by an observer can provide a series of observed images that creates a visual perception that kettle K is turning in a direction D₁ as depicted by the dashed/dotted lines of a spout S and handle Hof kettle K. Thus, it looks to the observer like person P is turning kettle K. Like image 10A, image 10B can be created by taking a plurality of primary images 12, such as photographs, at slightly different angles while person P rotates kettle K in her hand. The primary images can then be combined into a lenticular print that can be printed, for example, on a substrate to create a combined image and a specific lenticular lens can then be secured thereon to create the depicted visual perception when image 10B is viewed from different observation angles by an observer. Alternatively, the combined image can be printed directly to a rear surface of the lens instead of a substrate.

In some embodiments, two images can be used in a single lenticular print. In some embodiments, five images can be used in a single lenticular print. Additionally, in some embodiments, up to ten images can be used in a single lenticular print. Further, in some embodiments, up to thirty images can be used in a single lenticular print. Still, further, in some embodiments, more than 150 images can be used in a single lenticular print. The different primary images can be printed in an interlacing fashion on a substrate, such as paper, wood, plywood, composite material, plastic material, film, such as a vinyl film, or the like.

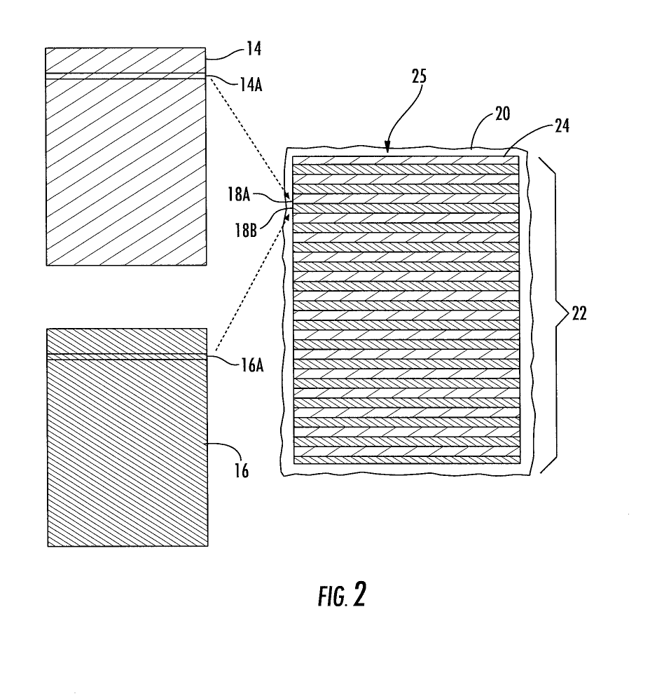

As an illustrative example of a schematic representation of a lenticular print process, FIG. 2 depicts a process of creating an embodiment of a combined image, generally designated 25. For simplicity, combined image 25 comprises a combination of two primary images, a first primary image 14 and a second primary image 16. Each primary image 14, 16 can be divided into multiple strips. Strips 14A, 16A are shown to represent a single strip in each respective image 14, 16. For example, first primary image 14 can be divided into successive multiple strips 14A (only a single strip illustrated) and second primary image 16 can be divided into strips 16A (only a single strip illustrated) by a computer program. These strips 14A, 16A of images 14, 16 can be printed as strips 18A, 18B using graphic media 24 such as ink on a substrate 20, such as paper, cardboard, wood, vinyl film, or the like, in a sequential alternating pattern 22 to create a new combined image 25. In the shown embodiment, the substrate 20 is a vinyl film. A lenticular lens (not shown in FIG. 2) can then be properly secured over new combined image 25 and vinyl film 20 so that the lens adds the three-dimensional perception that can provide at least some animation, depth and/or possible morphing or zooming features. The lenticular lens can be a transparent film that has angular or curved ridges that individually act as lenses. These individual lenses, or sub-licenses align with the interlaced strips of the different primary images to provide these visual perceptions.

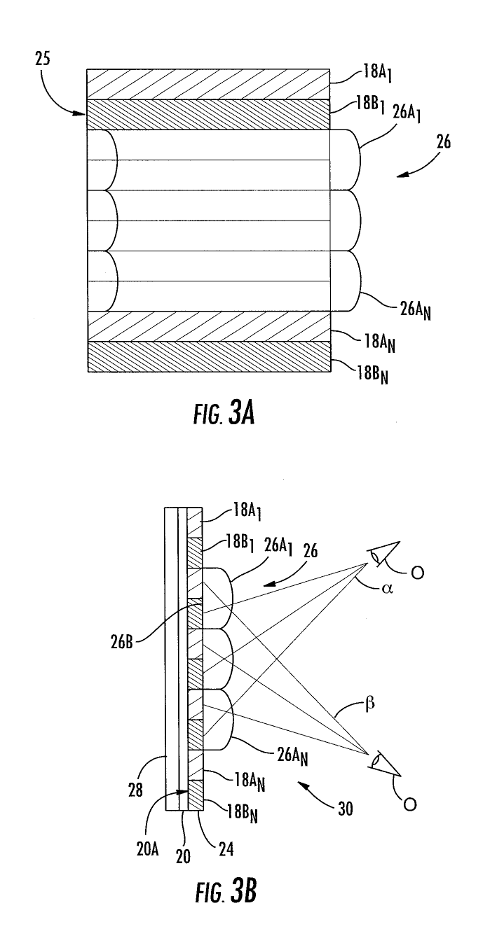

As shown in FIGS. 3A and 3B, after each image is divided or spliced into strips and interlaced or spliced with one or more similarly arranged images, these interlaced sequential strips 18A₁-18Aₙ and 18B₁-18Bₙ of the combined image 25 can be printed with a graphic media 24, such as ink, on a surface, or side, 20A of substrate 20 that can be bonded to a transparent substrate, such as a film, that forms a lenticular lens generally designated 26 (only partially shown) over the strips 18A₁-18Aₙ and 18B₁-18Bₙ printed in graphic media 24. Lenticular lens 26 can be a series of thin lenses 26A₁-26Aₙ or ridges formed, cut or molded into the transparent substrate. Alternatively, the interlaced strips of the combined images can be printed on a transparent vinyl film that comprises a series of thin lenses on one surface that forms the lenticular lens. With certain printing technology, lenses can be printed within the same printing operation as the interlaced image, either on both sides of a flat sheet of transparent material, or on the same side of a sheet of vinyl film. The image can be covered with a transparent sheet of plastic or with a layer of transparent film, which in turn can be printed with several layers of varnish to create the lenses.

As shown in FIG. 3B, to make a target, generally designated 30, substrate 20 can be applied to another substrate 28 to increase the rigidity of the overall structure. In some embodiments, substrate 28 can serve as the substrate on which the lenticular printing of the combined image can occur. In some embodiments, a lenticular lens 26 having a rear surface 26B on which combined image 25 is printed can be secured to substrate 28. Target 30 can be generally rigid in nature, both to keep the target's shape during successive use and to maintain the target's structure as simulated or live rounds are fired into target 30.

Lenticular lens 26 which can be a sheet or film itself and graphic media, or graphic layer 24, might not be sufficiently rigid for these needs even if graphic layer 24 is printed on a vinyl film 20. This is particularly true if the graphic layer is reverse printed directly onto the smooth underside 26B of the lenticular lens itself. For these reasons, under the lenticular and printed layers, a structural layer, such as substrate 28, can be added. Examples of materials that can comprise this structural substrate 28 can include foam core board and molded plastics, for example. Other materials can also be used. To help protect the trainees, substrate 28 can perforate or puncture when shot by the ammunition being used. Such non-electric three-dimensional immersive motion targets 30 allow for bullet strikes upon the actual target structure. These three-dimensional immersive motion targets 30 can be placed upon existent target-carrier devices in target training systems.

As shown in FIG. 3B, depending on the angle of viewing, an observer O will see a different image. For example, as observer O views target 30 from an angle α, individual thin lenses 26A₁-26Aₙ of lenticular lens 26 focus the view on strips 18B₁-18Bₙ to create a view of the observed image on the observer's retina of the eye. As observer O views target 30 from an angle β, individual thin lenses 26A₁-26Aₙ of lenticular lens 26 focus the view on strips 18A₁-18Aₙ to create a view of the observed image on the observer's retina of the eye.

Thin lenses 26A₁-26Aₙ can be accurately aligned with interlaces 18A₁-18Aₙ and 18B₁-18Bₙ of the images, so that light reflected off each strip can be refracted in a slightly different direction, but the light from all pixels originating from the same original image can be sent in the same direction. The end result can be that a single eye looking at the print can see a single whole image, but two eyes can see different images, which can lead to stereoscopic, animated, and/or transforming three-dimensional perception.

The quality of the interlaced image can be affected by different factors, including the resolution of the images. Standard rasterisation processes (RIP) can be used to create the interlacing. Alternatively, specific RIPs that are dedicated to lenticular printing can be used. With a standard RIP, the number of images can be twice the lineature (e.g., 2×300=600 dots per inch (“DPI”)) divided by the resolution of the lenticular screen (e.g., 60 lines per inch (“LPI”) which leads to 10 images), while using a specific RIP can allow interlacing at the flashing resolution (e.g. 2400 DPI or 4800 DPI). For example, up to as many or more than 120 images can be interlaced by printing at 4800 DPI and by using a 40 LPI cylindrical lenses array, which displays one after the other of the different images when view by an observer at changing angles of observation. Using spherical lenses can nearly double the number of images to over 200 images being combined to provide animation that can resemble short video sequences.

Different types of three-dimensional depth perception effects can be created by using different lenticular printing methods. For “transforming effects,” two or more very different pictures can be used, and the lenses can be designed to require a relatively large change in the angle of observation to switch from one image to another. This large change in the angle of observation can allow observers to easily see the original images, since small movements cause no change. Larger movement of the observer or the print can cause the image to flip from one image to another.

For “animation effects,” the distance between different angles of observation can be about a medium distance from each other, so that while both eyes usually see the same picture, moving a little bit can switch to the next picture in the series. Many sequential images can be used, with only small differences between each image and the next. These sequential images can be used to create an image that imitates motion or appears to move (“motion effect”), or can create a “zoom” or “morph” effect, in which part of the image expands in size or changes shape as the angle of observation changes.

For “stereopsis effects,” the change in viewing angle needed to change images can be small, so that each eye sees a slightly different view. These small changes in images can create a three-dimensional effect without requiring special glasses.

Additionally or alternatively, the targets can include substances that can be utilized to create a thermal signature. For example, a reusable heat generating mechanism can be created by super-cooling of sodium acetate to present a thermal signature to simulate a human heat source as observed by thermal sensors. For example, sodium acetate, water and a piece of aluminum can be included in a container, such as a pouch. The sodium acetate, water and piece of aluminum in the pouch can be manipulated to create a chain reaction to produce heat. These pouches can be reusable. Alternatively, activated charcoal to achieve a thermal signature to simulate human torso, or target, can be used to simulate a human heat source as observed by thermal sensors. A heat (“thermal”) signature only target or target system can be used. In one example, to enhance a thermal signature only target or target system, the amount of the heat generating substance modified to compensate for long range targeting in a confined space that does not allow engagement or firing from long distances. This enhancement can be accomplished by the reduction of both the scale-ratio of the target (torso and head silhouette) while the heat signature scale is minimized in the same relative manner. Thereby, the appropriate stand-off distance for long range targets can be created in a short-range or limited space.

Additionally, such thermal signature mechanism can be used with the visual mechanism described above on a target to further enhance the immersive training experience. The targeting system can be progressive threat/non-threat targets with thermal signatures. Animated ‘motion’ gesture shifting images on the targets can create threat or non-threat targeting. A target mover/carrier can be used to orientate target imagery towards a proper angled ‘response’ of an animated image and a shooter's path of travel through a course.

These firearm targets can have simulated human heat/thermal signatures on a two dimension target surface that can fit on common target carrying systems. As above, these non-electric three-dimensional immersive motion targets allow for bullet strikes upon the actual target structure. These three-dimensional immersive motion targets are placed upon existent target-carrier devices in target training systems.

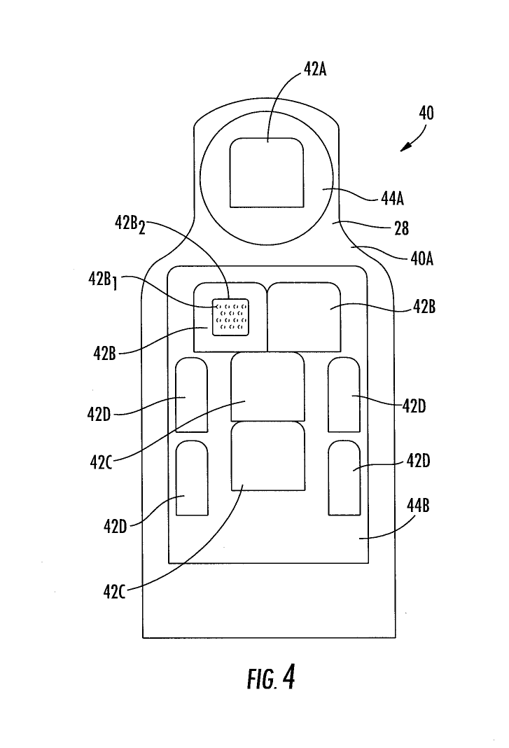

FIG. 4 shows a back side 40A of a target, generally designated 40. Target 40 can have a thermal signature creating structure that includes one or more structural substrates 28. Attached to substrate 28 can be substances that can be non-electrically heated or ignited to create a thermal signature for target 40. For example, air-activated chemicals can be attached to a back surface of substrate 28 that forms back side 40A of target 40. In some embodiments as shown in FIG. 4, air-activated chemicals can be disposed in one or more containers, such as metallized heat conductive film pouches, 42A, 42B, 42C, 42D that can have one or more air-activated chemicals, such as air-activated charcoal, that heat up when exposed to air. These pouches 42A, 42B, 42C, 42D can be perforated with a backing layer 42B₂ (shown with reference to pouch 42B only), such as an adhesive sticker, covering perforations 42B₁. Backing layer 42B₂ can be removed to expose perforations 42B₁ (shown with reference to pouch 42B only), and thus the air-activated charcoal, to air. Back side 40A of target 40 can also have one or more metallized heat conductive film layers 44A, 44B on which pouches 42A, 42B, 42C, 42D can be placed. For example, large pouch 42A can be disposed on a portion of target 40 that represents the head of target 40. Large pouches 42B can be disposed on target 40 at a position to represent a chest of target 40 and large pouches 42C can be disposed on target 40 at a position to represent an abdomen of target 40 with pouches 42B, 42C representing a torso of the target 40. Small pouches 42D can be positioned on target 40 to represent limbs, such as arms and hands on target 40. To better represent a thermal signature of an intended target 40, pouches 42A, 42B, 42C, 42D create a higher concentration of heat for the thermal signature, while film layers 44A, 44B create a lower concentration of heat for the thermal signature.

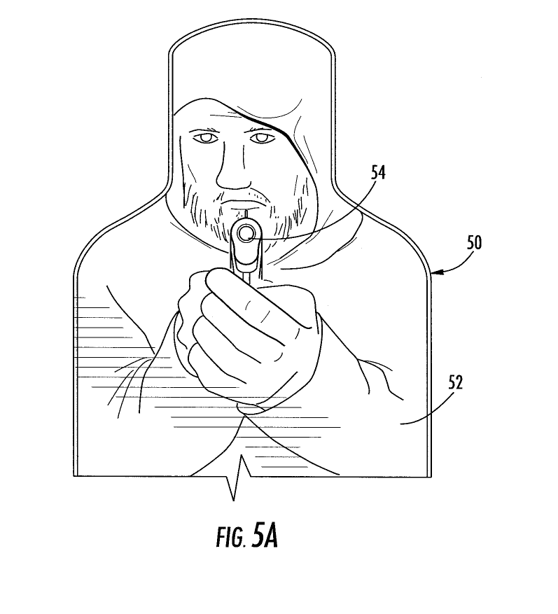

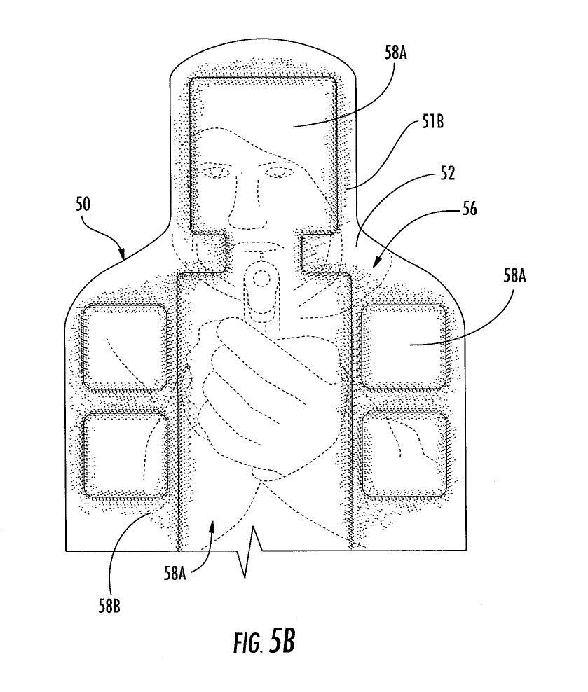

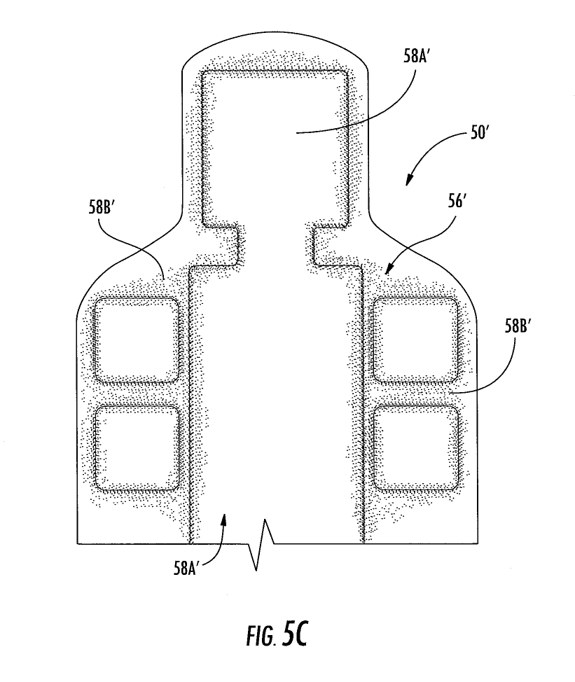

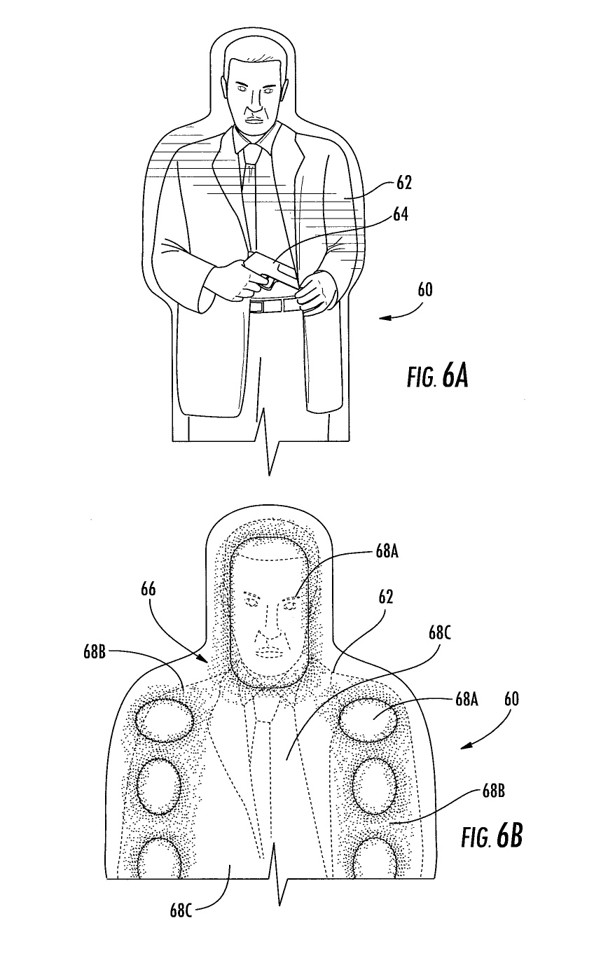

Similar constructions to that of target 40 can be used to create, for example, the targets depicted in FIGS. 5A-6B. In FIGS. 5A and 5B, a target 50 is provided that has a thermal signature creating structure with an image 52 thereon of a hooded man in a threat position holding a weapon 54. Image 52 as perceived or observed can be three-dimensional in nature. For example, image 52 can be created using a lenticular printing process as described above. Alternatively, image 52 can be a normal two-dimensional print. Target 50 can comprise, for example, one or more containers, such as pouches of one or more substances that can create heat without an electrical connection as described above to create a thermal signature 56 as shown in FIG. 5B that can be seen using a thermal imaging system, thermal weapon sight, a thermal scope, thermal goggles or a thermal sensor detection apparatus that has a viewable display or video output.

For example, thermal signature 56 created by the containers or heat conductive film layers can comprise zones 58A of a higher heat representing areas of higher core temperatures for the person depicted in image 52 (in dotted lines in FIG. 5B). Further, thermal signature 56 created by the containers or heat conductive film layers can comprise zones 58B of a lower heat representing areas of lower core temperatures for the person depicted in image 52. Thereby, thermal signature 56 can have a heat gradient similar to a live human being.

Also, as shown in FIG. 5C, a thermal signature only target 50′ can be provided with a thermal signature 56′ comprising higher heat zones 58A′ and lower zones 58B′. As stated above, the amount of the heat generating substance can be modified to compensate for long range targeting in a confined space that does not allow engagement or firing from long distances to enhance a thermal signature only target or target system. This enhancement can be accomplished by the reduction of both the scale-ratio of the target (torso and head silhouette) while the heat signature scale is minimized in the same relative manner. Thereby, the appropriate stand-off distance for long range targets can be created in a short-range or limited space.

Similarly, FIGS. 6A and 6B show a target 60 that has a thermal signature creating structure with an image 62 of a well-dressed man with his coat partially opened in a somewhat neutral position but holding a partially concealed weapon 64 in his coat. Image 62 as perceived or observed can be three-dimensional in nature, transformative in nature, and/or animated in nature. Alternatively, image 62 can be a normal two-dimensional print. Target 60 can comprise, for example, one or more containers, such as pouches of one or more substances that can create heat without an electrical connection as described above to a thermal signature 66. As above, thermal signature 66 created by the containers or heat conductive film layers can comprise zones 68A of a higher heat representing areas of higher core temperatures for the person depicted in image 62 (in dotted lines in FIG. 6B). Further, thermal signature 66 created by the containers or heat conductive film layers can comprise zones 68B of a lower heat representing areas of lower core temperatures for the person depicted in image 62. Thereby, thermal signature 66 can have a heat gradient similar to a live human being. As can be seen, thermal signature 66 of target 60 is different in presentation through the thermal viewing media than thermal signature 56 of target 50. In particular, a zone 68C in a middle portion of the chest of the person depicted in image 62 provides little or no heat signature. This heat free zone 68C can simulate an indication that the person depicted in image 62 is wearing body arm, such as a bulletproof vest. Thereby, a trainee can learn to recognize when to adjust his or her strike zone. Thereby, both thermal signatures 58 and 68 represent possible single personnel strike targets.

The thermal signature targets disclosed herein can also be used as an unmanned aerial vehicle (“UAV”) or unmanned vehicle (“UV”) target. In this instance, such three-dimensional thermal targets can simulate a geo-typical or geo-specific thermal signature (man/animal or machine-which could be a threat or non-threat target) that would likely occur in a specific region.

For training purposes, this target can be placed in a physical range and activated (adhesive backing removed to allow airflow to charcoal) to produce the desired mimicked thermal signature, found in the geo-specific area. A UAV pilot may be thousands of miles away at a computer operating the UAV. The pilot will see this thermal signature and have to make a decision to engage or not (based on what the target appears to be as indicated by its thermal signature). If the pilot does engage, then it can be determined how accurate the strike may be. To properly train the UAV pilot to distinguish thermal signatures from a remote location, these targets can be used. To assess the accuracy and fidelity of thermal target acquisition and recognition, these thermal targets offer a non-electric means of mimicking this thermal signature, which is the “natural state” in which these potential targets would be “in-theater.” Because of the manner of how this thermal signature of the practice target can mimic the thermal signature of an actual target and the ability to be able to operate the target system both “on and off grid,” these targets offer distinct tactical advantages for UAV Pilot Training as well.

In order for proper remote piloting/UAV training, i.e., target recognition to occur, geospatial targeting ranges during day/night operation can be implemented that use of dynamic thermal and/or three-dimensional targets as described above. For example, using these target systems, trainees can learn the difference between the thermal signature of two men within two feet of each other as compared to the thermal signature of a mule or donkey. Similarly, for example, trainees can learn the difference between the thermal signatures of several humans walking with a large herd of goats as compared to the thermal signature of an insurgent company level movement. Correct human thermal signature is necessary upon an accurate geospatial training environment. Geospatial intelligence can thus be used in order to more accurately confirm and strike insurgent forces instead of a lone goat herd in the middle of nowhere due to lack of cultural training or cultural immersion of UAV pilots thousands of miles from conflict area.

Various image enhanced, non-electric immersive motion firearm targets can be provided with images of multi-cultural aspects of potential areas where conflict can be expected to occur. As depicted in FIGS. 7-9, images can be presented that can help simulate multicultural aspects of both threat images or targets and non-threat images or targets to acclimate the trainee to the environment in which they will be required to operate. An image enhanced, non-electric immersive motion firearm target image can move from multi-cultural non-threat to a wide spectrum of threat or possible threat scenarios. The images used to create a lenticular printed target or targets can be, for example, actually non-threat progressive images that may appear to be threat or that turn into a threat.

For example, non-threat targets are shown in FIG. 7 that have cultural representations of the geographic area for which the trainees are training. For example, image 70 can include a man 72 and a woman 74 within a home 76. A painting 78 and a resting weapon 80 can give a trainee the feel of the environment in which he is entering. The man 72 and woman 74 can give cultural cues and provide possible familiarity to the trainee to provide a higher level of comfort if ever in such an environment. Further, image 70 can imitate motion of man 72 and woman 74 from a non-threat position to a threat position or from one non-threat position to another non-threat position. As shown in FIG. 7, woman 74 can move a kettle K in her hand in a direction D₂ and back between non-threating positions and man 72 can move a tool 86 in his hand in direction D₃ and back between non-threating positions.

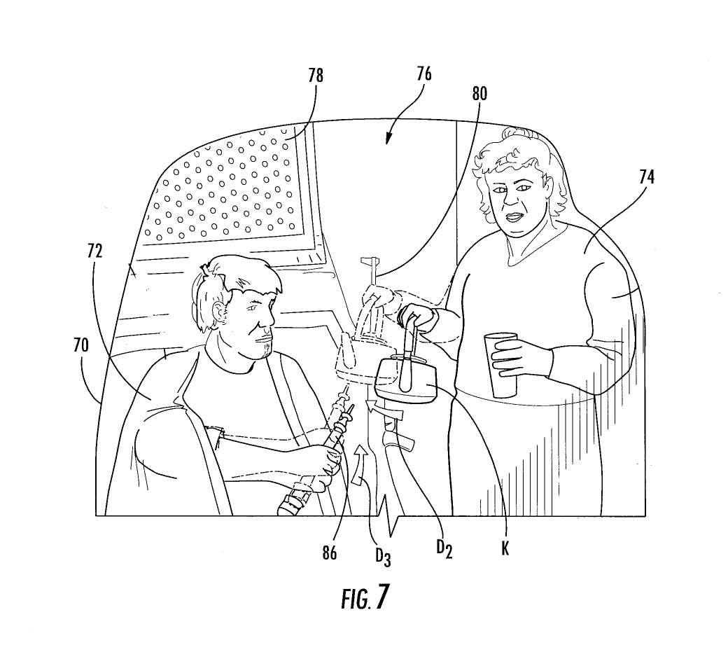

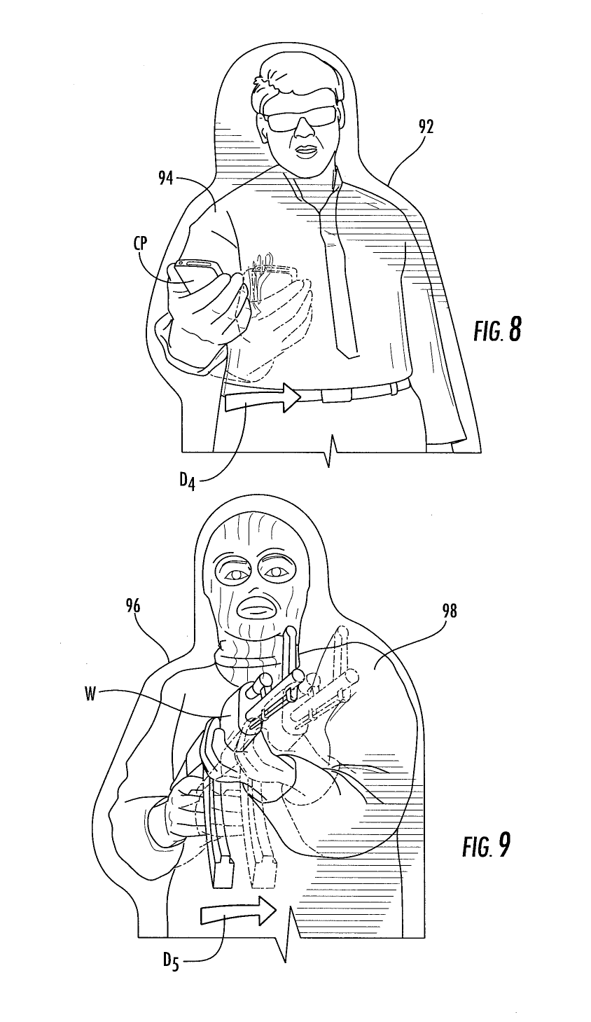

FIGS. 8 and 9 illustrate other images portraying non-threat images and threat images that can show movement when observed at different angles. In FIG. 8, an image 92 as perceived or observed is provide of a man 94 holding a cell phone CP in his hand. As the angle of observation changes, the hand with cellphone CP will move in a direction D₄ and back. While this is classified as movement between a non-threat position and a non-threat position, it can also be classified a low-level threat or if misinterpreted can be perceived by the observer as a threat, if the observer is not cued into the cellphone CP not being a weapon.

In FIG. 9, an image 96 as perceived or observed is provide of a woman 98 holding a weapon W in her hand. As the angle of observation changes, the weapon W will move in a direction D₅ and back. Such observed images are classified as movement between a threat position and a threat position, and appropriate action should be taken by the trainee.

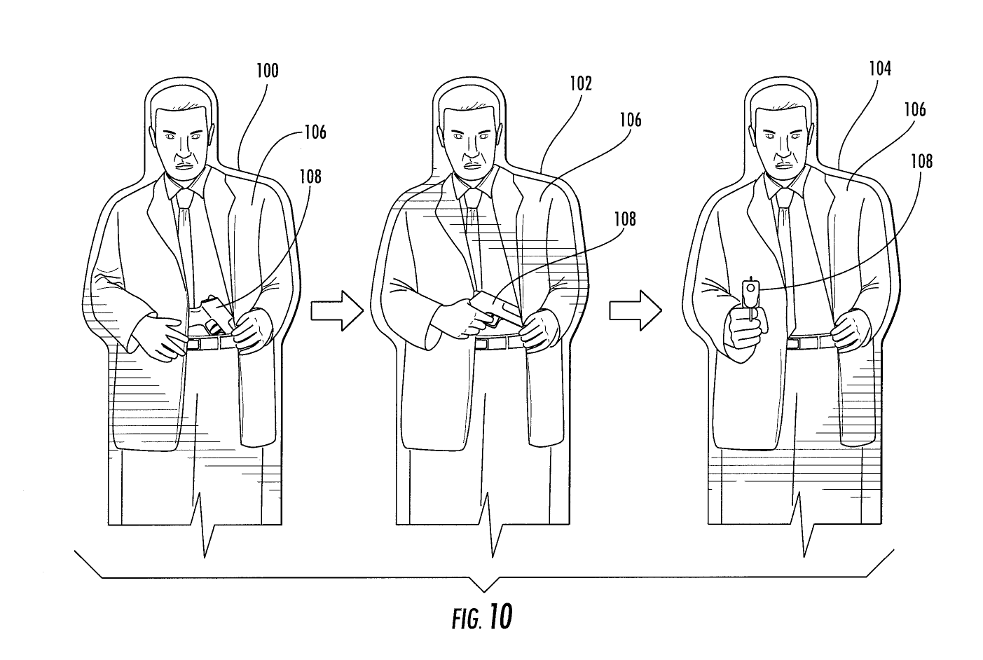

FIG. 10 illustrates a three image series of images that can be part of a single target that can provide a semi-transformative/semi-animated flow from a semi-threat to a high threat. In FIG. 10, a target can have three observable images 100, 102, 104 depending on the position of the observer/trainee and his or her angle of observation. In observed image 100, man 106 can be seen with an exposed weapon 108 on his body. It is unclear if he is reaching for weapon 108, so he is classified as a semi-threat. If the next observed image of man 106 was him putting his arms up or down to his side, man 106 may be considered a non-threat and no shots fired. If the next observed image is image 102 and man 106 is drawing his weapon, he is considered a threat and appropriate action should be taken. Further, if the next observed image is image 104 with man 106 having weapon 108 drawn and aimed, then the readiness of the trainee can be called into question if not hits have occurred beforehand. By having three distinct threat level observable images 100, 102, 104, a relatively large change in the angle of observation to switch from one image to another to give stable clear images while also providing a sudden change for quick decision making. Similar training scenarios can be accomplished using a series of images that provides a more animated motion as well.

The targets described above can be used in target systems that can comprise site layouts, facility layouts, target movers and/or target carriers. An example of a site layout can be a military operation in urbanized terrain (“MOUT”) site. The facility layouts can be, for example, shot houses. The target movers and carriers can be wired or wireless and swing-out from doorways or windows to provide a dynamic decision making experience in a MOUT site for the trainee. These carriers can physically move targets, sometimes along tracks, similar to a camera dolly. In these advanced systems, the three-dimensional or thermal (heat signature) targets can be positioned with this movement in mind for the trainee. In such target systems, the distance and angle of perspective from the viewpoint of the trainee and the potential target can be measured. The angle of view can be switched (morphed or transformed) by moving the target physically by means of a mover, while the trainee remains in situ. Thereby, the animated motion can be produced by the mover's action as it relates to the trainee's stationary position, and angle of view.

FIG. 11 illustrates a target system of a portable target range 110 having a fire position 112 where shooters can stand and fire through window 114 at a respective target. Target range 110 provides three lanes L, each with a movable carrier 116 that can have carrier clamps 118 for holding a target 120 that can move up and down the respective carrier 116. Carrier clamp 118 can also rotate in directions R₁.

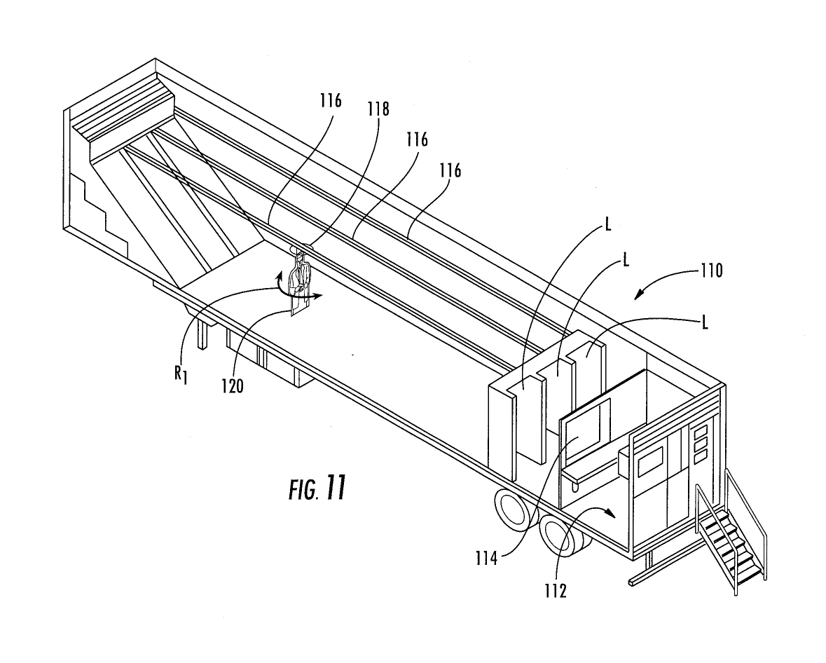

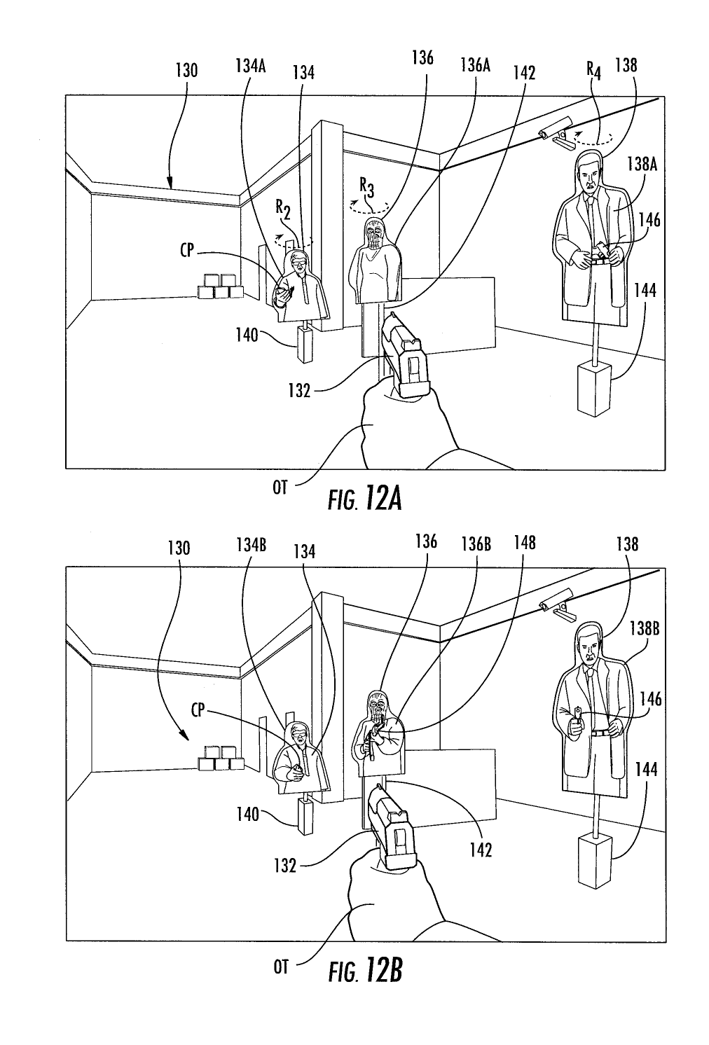

FIGS. 12A and 12B illustrate a target system 130 of a MOUT facility that is using image-enhanced low electric or non-electric targets. An observer/trainee OT can enter target system 130 with weapon 132 drawn as shown in FIG. 12A. As seen in FIG. 12A, any number of potential targets, such as potential targets 134, 136 and 138 which can reside on carriers 140, 142, and 144 respectively. Carriers 140, 142, and 144 can be stationary carriers that do not move, rotatable carriers that only rotate, or movable carriers that can move in different directions and possibly rotate. Observer/trainee OT observes non-threat image 134A of a man holding a cellphone CP and non-threat image 136A of a woman and semi-threat image 138A of a man with an observable weapon 146. Depending on the type of carrier that carriers 140, 142, and 144 are, images 134A, 136A and 138A can change by rotation, for example by possible rotation in respective directions R₂, R₃, and R₄ (shown in dotted lines), or by other movement of the respective carrier 140, 142, and 144 or by movement of observer/trainee OT which can cause the angle of observation to change. As seen in FIG. 12B, as the observation angle changes, observer/trainee OT will perceive new observed images on targets 134, 136 and 138. In particular, observer/trainee OT will now see a new non-threat image 134B of the man still holding cellphone CP and threat image 136B of the woman with a machine gun 148 drawn and a threat image 138B of the man with weapon 146 drawn and aimed. Such changing observable imagery can create more realistic and immersive training scenarios that can improve the training an observer/trainee OT receives.

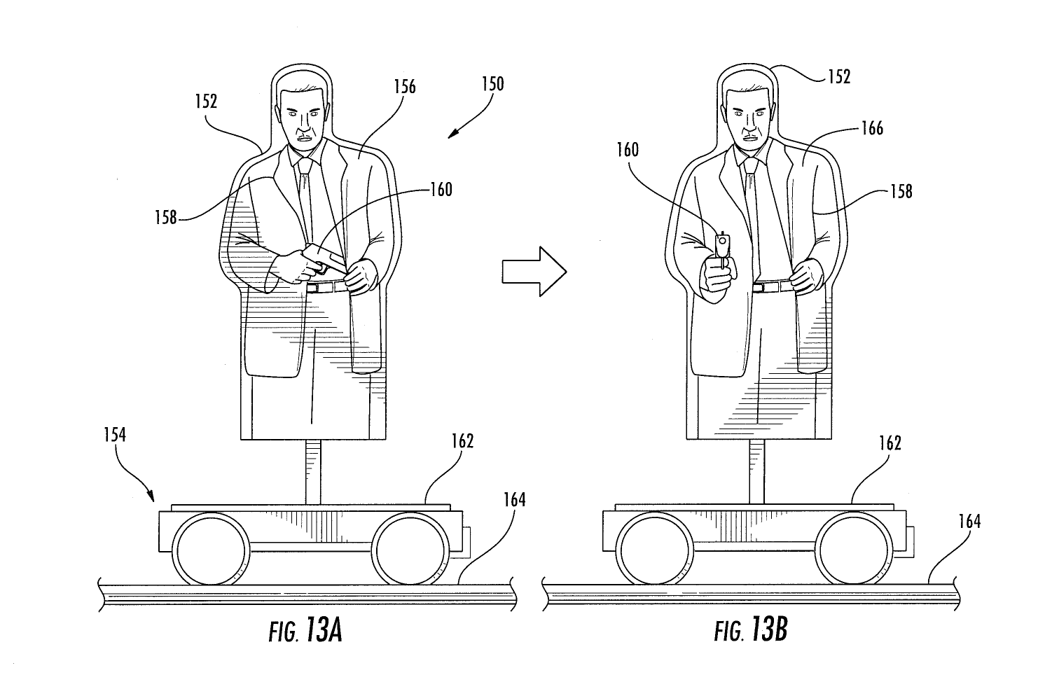

FIGS. 13A and 13B illustrate another target system, generally designated 150, which comprises one or more targets 152 on one or more movable carriers 154. In particular, FIG. 13A shows a target 152 with an observable threat image 156 of a man 158 drawing a weapon 160. Target 152 can reside on movable carrier 154 that can comprise a dolly 162 and rail 164 system. As dolly 162 moves along rail 164, the angle of observation will change for the observer/trainee so that an observable high threat image 166 will appear on target 152 with man 158 having drawn and aimed weapon 160 as shown in FIG. 13B. Such dolly 162 and rail 164 system, while shown with observable images of a man, can also be beneficial for creating visual enhanced and/or thermal signature recognition targets of large targets, such as tanks, trucks, trains, and other vehicles with or without images of associated personnel. Further, multiple dolly and rail systems can be used to a create target system 150, or in conjunction with other target systems. Such dolly and rail system can be configured to operate with electricity, without electricity, or with low electricity.

Additional description of target systems and visually enhanced immersive motion firearm targets as used in threat/non-threat training of subject personnel are provided below in view of four different tiers of conflict. These targets and target systems can employ cultural immersion images and simulated environments tied to a geo-specific location. Role-players from the specific geographic location for which the training is intended can be photographed using three-dimensional photography. These role-players can be beneficial, because they can be aware of the customs and cultures of the specific geographic location.

### I. Soldier/Peace Officer: Instruction in Potential Threats

Various visually enhanced immersive motion firearm targets can be provided with images of multi-cultural aspects of potential area where conflict can be expected to occur. In such training targets, a threat target can be provided. This threat target can be an image of a person who the trainee may typically perceive as a threat. Alternatively, threat target can be an image of a person who the trainee would not typically perceive as a threat.

A visually enhanced immersive motion firearm target image can move from multi-cultural non-threat to a wide spectrum of threat or possible threat scenarios. The images used to create a lenticular printed target or targets can be, for example, actually non-threat progressive images that may appear to be a threat or that turn into a threat. For example, a non-threating target as shown in FIG. 1 or a threating target as shown in FIG. 10. The images can be targets that are three-dimensional in nature, transformative in nature, and/or animated in nature and include cultural representations of the geographic area for which the trainees are training.

The visually enhanced immersive motion firearm targets can be used in stationary night operations/low light engagements. Images can be presented that provide various culturally appropriate dress for appearances in public and/or various private or in-home states of cultural dress. For example, in a country that observes traditional religious customs, a female might dress one way when outdoors or indoors when in the company of non-family males and in a different way when only around her family. Thus, the target system can create an indoor environment with images that can be presented on a potential target that can be a person, who might be dressed one way which may create an environment where a threat can arise due to escalating cultural outrage caused by non-family members within a family environment. Alternatively, images can be presented on a target of a person who appears to be a non-threat which might cause the trainee to consider further if the person in the next image is a potential threat depending on the person's stance, demeanor, and whether the person may be holding a weapon.

Visually enhanced immersive motion firearm targets can enable greater target recognition as to whether a person in the combined images is a threat or a non-threat through motion of body parts or objects being held in the images to provide better training to the trainee in his or her shoot/no shoot judgment. For example, as shown in FIGS. 9, 12A and 12B and as discussed above, a man can by means of “hand” in motion due to the lenticular printing reveal that a metallic object in his hand is a phone and he can be classified as a non-threat in this example and no shot should be taken.

### II. War Fighter/Riot Control: Instruction in Threats in a Chaotic Environment

Various threat/non-threat visually enhanced immersive motion firearm targets can be provided to train military or police personal in combat and riot control using lenticular printing to provide three-dimensional features to the targets and to provide morphing or zooming effects. For example, an image of a person who is a non-threat can be provided on the target that can be seen at one angle and an image of that person in surrendering pose can be seen at a different angle on the target. An image of a person who is a non-threat can be provided on the target that can be seen at one angle and an image of that person fleeing can be seen at a different angle on the target. An image of a person who is a non-threat can be provided on the target that can be seen at one angle and an image of that person posing a threat can be seen at a different angle on the target. An image of a person who is a threat may be provided on the target that can be seen at one angle and an image of that person in a non-threatening pose can be seen at a different angle on the target. An image of a person who is a threat may be provided on the target that can be seen at one angle and an image of that person in a surrendering pose can be seen at a different angle on the target.

Further, more than two images can be provided by the lenticular printing. For example, an image of a person who is a threat may be provided on the target that can be seen at one angle. Then, an image of that person in a surrendering pose can be seen at a different angle on the target followed by an image of that person in a different threatening pose can be seen at another angle.

Instead of targets on a stationary carrier system, the visually enhanced immersive motion firearm targets can be moving targets on a moving target carrier system. The carrier can be operated by wired or wireless communication with an operator or by a computer. For example, the targets can move on tracks to provide forward, back, and/or oblique movement as well as possible circular motion. The lenticular printed images used on the targets can be lawful enemy combatant or unlawful combatants. Further, the images combined on the target through lenticular printing can disguised combatants who are not posing a threat but that have tells or giveaways that the person in the given image may be a combatant. Such tells or giveaways may be cultural in nature. The images of disguised combatants who are not posing a threat can also be combined on the target through lenticular printing with images of the disguised combatants posing a threat. Similarly, the images combined on the target through lenticular printing can be unlawful civil disobedient persons who alternatively pose a threat and do not pose threat.

### III. Operator/SRT-SWAT: Instruction in Progressive Threat Target Selection

Various threat/non-threat visually enhanced immersive motion firearm targets can provide animated image motion using the lenticular printing and lenticular lenses for common threats in very hostile environments with bullet strike registry. The visually enhanced immersive motion firearms target can provide animation through a series of sequential images. The animation can be, for example, a series of images that illustrate the movement of a closed door to a cracked door with weapon protruding, a closed door to an exploding door to indicate a fatal backdraft, or a door/hall that has been booby trapped. Additionally, the animation can be, for example, an empty window to silhouette in a corner of a window to a human threat in the window with bullet strike registry. These targets can also be used in stationary night operations or low light engagement training. Such targets can include features to create a thermal signature as described above and can include a round strike registry.

### IV. Master Combatant: Instruction in Progressive Moving Threat Target Selection

Various threat/non-threat visually enhanced immersive motion firearm targets can be provided on moving carriers to form a target system. For example, the carriers can be on an s-track that can provide forward, back, and oblique movement as well as circular motion. The targets through lenticular printing can provide images that can progress on a threat scale from a low threat to high threat with different targets being at different levels on the threat scale at any one time. This mixture of threat levels can help the trainee distinction in a combat situation which target is the most dangerous and should be shot first.

The visually enhanced immersive motion, firearm targets, and target systems can be considered different from conventional targets and target ranges in that this system does not require external devices, such as three-dimensional projector or display, to give motion to the target image. This process also gives immersive three-dimensional spatial training by providing image foreground, image mid-ground, and image background. The visually enhanced immersive system can provide training that is based on motion of the target image itself and can bring in the factors of visual perception in relation to parallax and binocular vision, occlusion, peripheral motion, and depth from motion (which indicates time to contact). All of these data points allows for greater three-dimensional immersive training in a live fire or simunition range.

Three-dimensional immersive motion, firearm targets and target systems allow for greater adaptability and response to new/current and emerging threats by allowing for live-fire training in the theater of operations without the need to rotate back to the troops' country of origin for training and re-deployment. In this manner, spear-head commanders can be given greater flexibility, with more efficient immersive training.

These targets, target systems and related methods of the present subject matter can provide a realistic, fully immersive training environment that also reinforces complex decision-making skills. These targets, target systems and related methods can be incorporated into existing and developing service training programs and can provide decision-making stimuli for infinitely repeatable and rapidly reconfigurable scenarios. These targets, target systems and related methods of the present subject matter can provide an adaptable and affordable training capability that can be modified based on changes in the operational and cultural environment.

It will be understood that various details of the presently disclosed subject matter may be changed without departing from the scope of the presently disclosed subject matter. Embodiments of the present disclosure shown in the drawings and described above are exemplary of numerous embodiments that can be made within the scope of the presently disclosed subject matter. It is contemplated that the configurations of the targets, target systems, and related methods can comprise numerous configurations other than those specifically disclosed. Furthermore, the foregoing description is for the purpose of illustration only, and not for the purpose of limitation.

What is claimed is:

1. A target comprising:
a substrate forming a target body and having a front side;
a combined image disposed on the front side of the substrate, the combined image comprising a combination of at least two primary images of a potential target provided through lenticular printing; and
a lenticular lens disposed over the combined image.

2. The target according to claim 1, wherein the combined image and the lenticular lens are configured to generate a first observed image of a non-threat image on the target body when observed from a first angle and a second observed image of a threat image on the target body when observed from a second angle.

3. The target according to claim 1, wherein the combined image and the lenticular lens are configured to generate a first observed image of a non-threat image on the target body when observed from a first angle and a second observed image of a non-threat image on the target body when observed from a second angle.

4. The target according to claim 1, wherein the combined image and the lenticular lens are configured to generate a series of observed images of the potential target as an angle of observation changes for the observer.

5. The target according to claim 4, wherein the combined image and the lenticular lens are configured to generate the observed images of the potential target to imitate motion of the potential target.

6. The target according to claim 4, wherein the combined image and the lenticular lens are configured to generate the series of observed images of the potential target are sequential.

7. The target according to claim 1, wherein the combined image and the lenticular lens are configured to generate a three-dimensional observed image of the potential target.

8. The target according to claim 1, wherein the combined image and the lenticular lens are configured to generate at least one of a transforming effect, an animated effect, or a stereopsis effect to generate the observed image of the potential target when viewed by an observer.

9. A target comprising:
a substrate forming a target body;
at least one substance disposed on the substrate configured to create a thermal signature mimicking a potential target.

10. The target according to claim 9, wherein the at least one substance comprises a chemical composition.

11. The target according to claim 9, wherein the at least one substance comprises an air-activated charcoal that produces heat when exposed to air.

12. The target according to claim 11, wherein the air-activated charcoal is disposed in a container on a back surface of the substrate with an adhesive layer that is removable to allow air flow into the container to begin heat activation of the charcoal.

13. The target according to claim 9, wherein the at least one substance is configured to not require electric power to ignite in order to generate the thermal signature.

14. The target according to claim 9, further comprising an image of a person or physical object disposed on a front side of the substrate.

15. The target according to claim 9, further comprising a combined image disposed on a front side of the substrate, the combined image comprising a combination of at least two primary images of a potential target provided through lenticular printing, and a lenticular lens disposed over the combined image so that the combined image and the lenticular lens are configured to generate an observed image of the potential target when viewed by an observer.

16. The target according to claim 15, wherein the combined image and the lenticular lens are configured to generate a first observed image of a non-threat image on the target body when observed from a first angle and a second observed image of a threat image on the target body when observed from a second angle.

17. The target according to claim 15, wherein the combined image and the lenticular lens are configured to generate a first observed image of a non-threat image on the target body when observed from a first angle and a second observed image of a non-threat image on the target body when observed from a second angle.

18. The target according to claim 15, wherein the combined image and the lenticular lens are configured to generate a series of observed images of the potential target as an angle of observation changes for the observer.

19. The target according to claim 18, wherein the combined image and the lenticular lens are configured to generate the observed images of the potential target imitate motion of the potential target.

20. The target according to claim 15, wherein the combined image and the lenticular lens are configured to generate a three-dimensional observed image of the potential target.

21. The target according to claim 15, wherein the combined image and the lenticular lens are configured to generate at least one of a transforming effect, an animated effect, or a stereopsis effect to generate the observed image of the potential target when viewed by an observer.

22. A target training system comprising
at least one carrier; and
a target disposed on the at least one carrier comprising:
a substrate forming a target body; and
at least one substance disposed on the substrate configured to create a thermal signature mimicking a potential target.

23. The system according to claim 22, wherein the at least one substance comprises a chemical composition.

24. The system according to claim 23, wherein the at least one substance comprises an air-activated charcoal that produces heat when exposed to air.

25. The system according to claim 24, wherein the air-activated charcoal is disposed in a container on a back surface of the substrate with an adhesive layer that is removable to allow air flow into the container to begin heat activation of the charcoal.

26. The system according to claim 22, further comprising an image of a person or physical object disposed on a front side of the substrate.

27. The system according to claim 22, further comprising a combined image disposed on a front side of the substrate, the combined image comprising a combination of at least two primary images of a potential target provided through lenticular printing, and a lenticular lens disposed over the combined image so that the combined image and the lenticular lens are configured to generate an observed image of the potential target when viewed by an observer.

28. The system according to claim 22, wherein the combined image and the lenticular lens are configured to generate at least one of a transforming effect, an animated effect, or a stereopsis effect to generate the observed image of the potential target when viewed by an observer.

29. A target training system comprising
at least one carrier; and
a target disposed on the at least one carrier comprising:
a substrate forming a target body and having a front side;
a combined image disposed on the front side of the substrate, the combined image comprising a combination of at least two primary images of a potential target provided through lenticular printing; and
a lenticular lens disposed over the combined image.

30. The system according to claim 29, wherein the combined image and the lenticular lens are configured to generate a first observed image of a non-threat image on the target body when observed from a first angle and a second observed image of a threat image on the target body when observed from a second angle.

31. The system according to claim 29, wherein the combined image and the lenticular lens generate a series of the observed images of the potential target as an angle of observation changes for the observer.

32. The system according to claim 31, wherein the combined image and the lenticular lens are configured to generate the observed images of the potential target imitate motion of the potential target.

33. The system according to claim 31, wherein the combined image and the lenticular lens are configured to generate the series of observed images of the potential target are sequential.

34. The system according to claim 29, wherein the combined image and the lenticular lens generate a three-dimensional observed image of the potential target.

35. The system according to claim 29, wherein the combined image and the lenticular lens are configured to generate at least one of a transforming effect, an animated effect, or a stereopsis effect to generate the observed image of the potential target when viewed by an observer.

36. A method of creating a target, the method comprising:
providing a substrate having a front side and a back side;
shaping the substrate into a target body; and
attaching a substance on the back side of the substrate in a pattern that, when the substance is activated, creates a thermal signature mimicking a potential target.

37. The method according to claim 36, wherein attaching a substance comprises placing the substance in one or more containers that are positioned on the back side of the substrate in a pattern.

38. The method according to claim 37, wherein the container comprises an adhesive layer that is removable to allow air flow into the container to activate the substance.

39. The method according to claim 38, wherein the substance comprises an air-activated charcoal that produces heat when exposed to air.

40. The method according to claim 36, further comprising adding an image on the front side of the substrate.

41. The method according to claim 40, wherein the image is a combined image comprising a combination of at least two primary images of a potential target provided through lenticular printing and further comprising securing a lenticular lens over the combined image so that the combined image and the lenticular lens generate an observed image on the target body when viewed by an observer.

42. The method according to claim 36, further comprising printing a combined image comprising a combination of at least two primary images of a potential target onto a rear surface of the lenticular lens so that the combined image and the lenticular lens generate an observed image of the potential target when viewed by an observer and securing a lenticular lens to the front side of the of the substrate.
